(19) United States
(12) Patent Application Publication
(10) Pub. No.: US 2008/0028402 A1
(43) Pub. Date: Jan. 31, 2008

(54) Method of setting operation environment and computer system

(75) Inventor: Kenichi Senoo, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/878,768

(22) Filed: Jul. 26, 2007

(30) Foreign Application Priority Data
Jul. 27, 2006 (JP) 2006-204286

(51) Int. Cl. G06F 15/177; G06F 9/455

(52) U.S. Cl. 718/1; 709/220

(57) ABSTRACT

In a method of setting an operation environment of a first computer using a first disk to a second computer using a second disk, an operation of the first computer is suspended. The method further includes producing a list of files contained in a copy image as at least a part of a disk image of the first disk, after the operation of the first computer is suspended; copying execution context of the first computer to the second computer after the operation of the first computer is suspended; restarting an operation of the second computer after the producing a list of files and the copying of execution context; and referring to the list after the restarting to copy the copy image from the first disk to the second disk. The copy image may be an entire of the disk image.

### TECHNICAL FIELD

The present invention relates to a technique to set an operation environment of a computer to another computer in a computer system.

### BACKGROUND ART

There is known a server system to provide various services via a network. In the server system, there is a case that a task executed by a server in the operation state is transferred to another server for the purpose of performance enhancement, load distribution and maintenance. In this case, it is necessary to suspend the task of the server in the operation state and entirely transfer an operation environment of the server to another server. Particularly, when a disk is not shared, a disk image of the server in the operation state needs to be copied to a disk of the other server.

A method of transferring a server operation environment in a related art is as follows. First, a hardware configuration (slot position of IO card, etc.) is compared between a source server and a destination server prior to transfer of an operation environment, and it is confirmed that a disk image can be taken over. Thereafter, the operation environment starts to be transferred. In a process of transferring the operation environment, a flow as shown in FIG. 1 is performed.

First, an operation of a source server is suspended (step S110). Subsequently, a disk image of a source server is copied from a disk of the source server to a disk of a destination server (step S120). Execution context is also copied from the source server to the destination server (step S130). The execution context here is contents of a register set and a main memory used by a program under execution. When the copy of the disk image and execution context is completed, the operation of the destination server is made to start. Therefore, the suspended task is restarted in the destination server (step S140). Thus, the task of the source server is taken over to the server destination server.

In conjunction with the above description, related techniques are known as follows.

Japanese Patent Application Publication (JP-A-Heisei 10-283210) describes a method of transferring a virtual machine (VM) among a virtual machine system configured on a plurality of actual machines. According to this method, a magnetic disk unit is shared by a source machine and a destination machine. The source virtual machine system is provided with means adapted to notify a logical name of a real resource corresponding to configuration data on the VM to transfer. A virtual machine system of a destination is provided with means adapted to generate the same VM configuration on the basis of a received logical name.

Due to a large disk image size of plural G bytes, time required to copy a disk image (steps S120) is extremely long. It can be said that transfer time of a server operation environment, i.e. a period of time from suspending a task (step S110) to restarting the task (step S140) is substantially controlled by copy time of the disk image. From a viewpoint of a service provider, it is desirable that a suspension time of the task is made to be as short as possible.

### SUMMARY

Accordingly, an object of the present invention is to provide a computer system in which a suspension time of a task can be shortened when an operation environment of a computer is set to another computer.

In an exemplary aspect, the present invention relates to a method of setting an operation environment of a first computer using a first disk to a second computer using a second disk. The method includes suspending an operation of the first computer; producing a list of files contained in a copy image as at least a part of a disk image of the first disk, after the operation of the first computer is suspended; copying execution context of the first computer to the second computer after the operation of the first computer is suspended; restarting an operation of the second computer after the producing a list of files and the copying of execution context; and referring to the list after the restarting to copy the copy image from the first disk to the second disk. The copy image may be an entire of the disk image.

In another exemplary aspect of the present invention, a computer includes a copy determining module configured to determine whether an entity of an access target data exists when a disk is accessed; and a copying module configured to request an apparatus which is accessible to a source disk in which the access target data is stored, to copy the access target data to the disk when it is determined that the entity of the access target data does not exist.

In a still another exemplary aspect, the present invention relates to a computer system in which an operation environment of a first computer using a first disk is set to a second computer using a second disk. The computer system a copy list producing module configured to produce a copy list of files contained in a copy image of at least a part of a disk image of the first disk of the first computer; and a context copying module configured to copy execution context of the first computer to the second computer after an operation of the first computer is suspended. The produced copy list is stored in the second disk.

In a still another exemplary aspect, the present invention relates to a computer-readable software product for realizing a method. The method includes analyzing a log file indicating a record of operations on a file on a first disk; allocating a peculiar ID to the file when the last one of the operations of the record is a modify operation; and producing a list of the peculiar ID, a name of the file, and a copy data indicating whether the file has been already copied.

According to the present invention, the execution context is copied to the second computer during a time period from the suspension of an operation of the first computer to the restart of the second computer. With the copy image on the first disk, a list of files contained in the copy image, and a copy of the entity of the copy image is not carried out. The copy of the entity of copy image is carried out by referring to the produced list after the second computer is restarted. Therefore, the time from the suspension of the first computer to the restart of the second computer can be shortened.

According to the present invention, it is made possible to shorten an interrupt time of a task in transferring an operation environment of a computer to another computer.

### BRIEF DESCRIPTION OF THE DRAWINGS

The above and other objects, advantages and features of the present invention will be more apparent from the following description of exemplary embodiments taken in conjunction with the accompanying drawings, in which;

FIG. 1 is a flowchart showing a method of setting a server operation environment according to a related art;

FIG. 2 is a block diagram showing a schematic configuration of a server system according to the present invention;

FIG. 3 is a flowchart showing a method of setting a server operation environment according to the present invention;

FIG. 4 is a diagram to explain an effect of the present invention;

FIG. 5 is a block diagram showing a configuration of a server system according to a first exemplary embodiment of the present invention;

FIG. 6 is a conceptual diagram showing an example of a copy list;

FIG. 7 is a conceptual diagram showing an example of a hash table;

FIGS. 8A and 8B are flowcharts showing a method of copying a copy image in the present exemplary embodiment;

FIG. 9 is a block diagram showing a configuration of the server system according to a second exemplary embodiment of the present invention;

FIG. 10 is a conceptual diagram showing an example of a copy list;

FIG. 11 is a conceptual diagram showing a disk image in a third exemplary embodiment of the present invention;

FIG. 12 is a flowchart showing a method of setting a server operation environment according to the third exemplary embodiment;

FIG. 13 is a block diagram showing a configuration of an example of the server system according to the present invention;

FIG. 14 is a block diagram showing the configuration of another example of the server system according to the present invention;

FIG. 15 is a conceptual diagram showing an example of a base list in the present invention;

FIGS. 16A to 16C are conceptual diagrams showing an example of a base image and a copy image in the present invention;

FIGS. 17A and 17B are conceptual diagrams showing an example of adding/changing a disk image;

FIG. 18 is a conceptual diagram showing an example of producing a log file;

FIGS. 19A and 19B are conceptual diagrams showing an example of producing a copy list from the log file; and

FIG. 20 is a conceptual diagram showing another example of the base image and the copy image in the present invention.

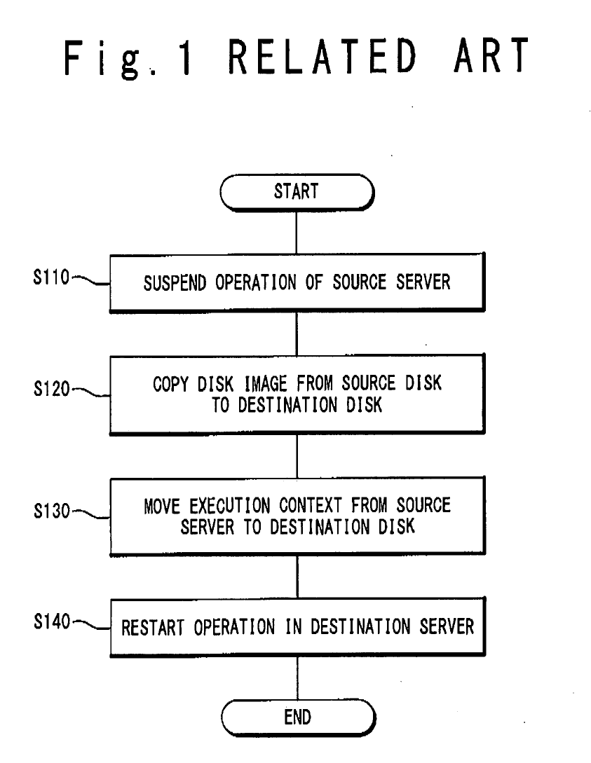

### EXEMPLARY EMBODIMENTS

Hereinafter, a computer system and a method of setting a same operation environment as a first computer to a second computer according to exemplary embodiments of the present invention will be described with reference to the attached drawings. A computer system includes an autonomous computer system, a utility computer system, a grid system, and a virtual system or the like. In the present invention, a server system for providing various services is exemplified as the computer system.

### [Outline]

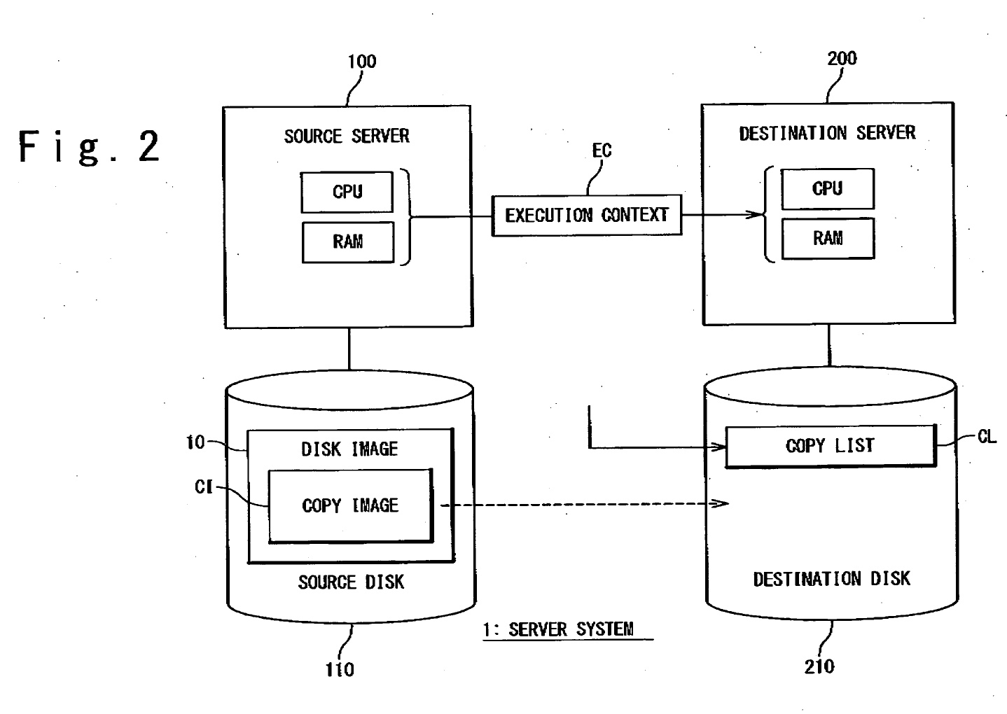

At first, an outline of the present invention will be described. FIG. 2 conceptually shows a server system 1 according to the present invention. In the present invention, an operation environment of a source server 100 is set to a destination server 200. The source server 100 uses a source disk 110, and the destination server 200 uses a destination disk 210. It is assumed that the source disk 110 is not shared by the destination server 200.

An operation environment of the source server 100 includes an execution context EC of the source server 100 in addition to a disk image 10 of the source disk 110. The execution context EC includes data held by registers in a CPU and data stored in a main memory (RAM) which are used by a program under execution. That is, the execution context EC is a bundle of data, based on which an operation state (execution state) of a computer at a certain point of time can be reproduced.

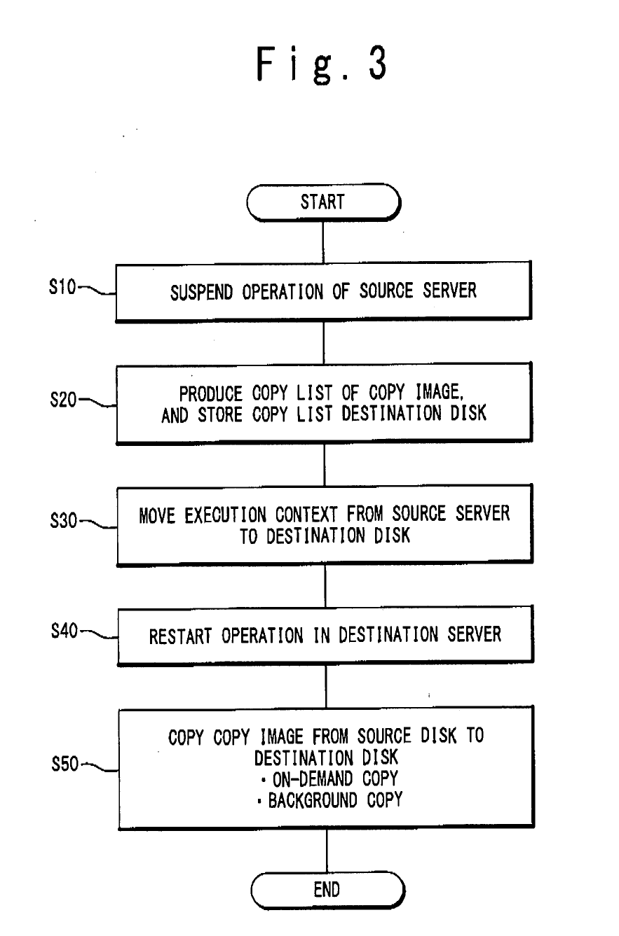

FIG. 3 is a flowchart showing a method of setting a same operation environment as a source server to a destination server according to the present invention. An operation environment setting method according to the present invention will be described with reference to FIGS. 2 and 3. First, an operation of the source server 100 is suspended or stopped (step S10). Therefore, a task executed by the source server 100 is interrupted or suspended.

Next, a list (index) of files included in a copy image CI to be copied from the source disk 110 to the destination disk 210 is produced. The copy image CI is at least a part of the entire disk image 10 of the source disk 100. A list to be produced is also referred as a copy list CL hereinafter. The produced copy list CL is stored in a disk which is accessible by the destination server 200. For example, the copy list CL is stored in the destination disk 210 as shown in FIG. 2 (step S20). Furthermore, the execution context EC of the source server 100 is copied to the destination server 200. That is, the execution context EC is transferred or copied from the source server 100 to the destination server 200 (step S30).

Next, an operation is restarted in the destination server 200 (step S40). That is, the destination server 200 restarts a suspended task in response to reception of the execution context EC. At this time, an entity of the copy image CI is not yet copied. Instead, the copy list CL as a file list of the copy image CI is stored in a disk which is accessible by the destination server 200.

Thereafter, the copy image CI is copied from the source disk 110 to the destination disk 210 during the execution of the task by the destination server 200 (step S50). The copy image CI is copied based on the above-described copy list CL. For example, the copy image CI is copied in an on-demand system in response to a request from the destination server 200. The copy image CI may also be copied in the background of an operation of the destination server 200. When a copy of the copy image CI is completed, the process to transfer an operation environment is finished.

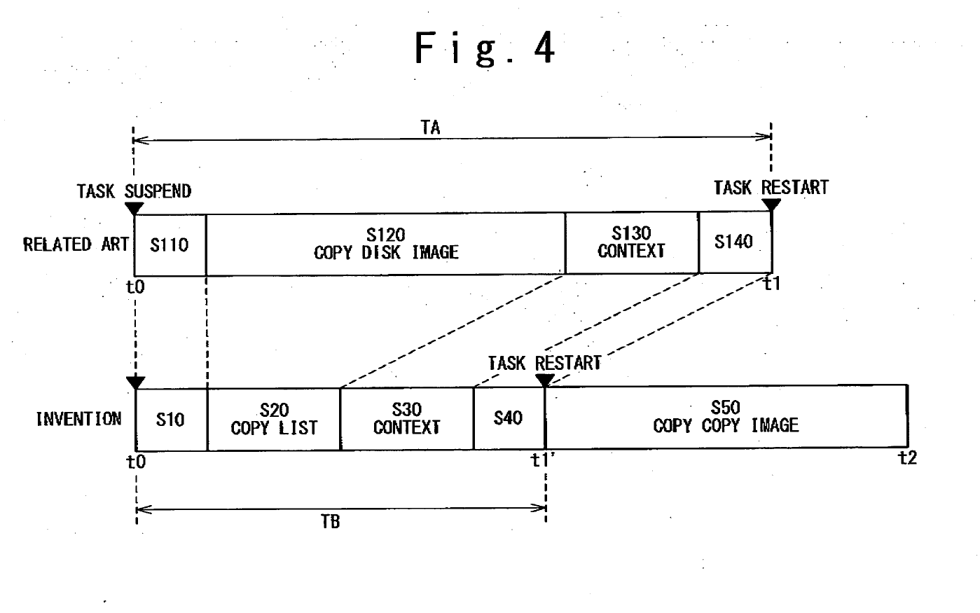

FIG. 4 shows comparison between a related art and the present invention. According to the related art, a copy of an entire disk-image (step S120) and a copy of execution context (step S130) are executed after interrupting a task at time t0. Thereafter, a task is restarted in a destination server at time t1.

According to the present invention, the execution context EC are copied in a period from interrupting a task at time t0 to restart a task at time t1′ (step S30). However, with respect to the copy image CI on the transfer source desk 110, a file list thereof, which is the copy list CL, is exclusively produced (step S20), and an entity of the copy image CI is not copied. In that stage, an operation is restarted in the destination server 200. Since the entity of the copy image CI is not copied, a period from a task interruption to a task restart is shortened from TA to TB. That is, an interruption time of the task is shortened.

With respect to an entity of the copy image CI, an on-demand copy or a background copy can be performed after restarting an operation and during execution of the task in the destination server 200. It is because the copy list CL is produced to be accessible by the destination server 200. A copy of the copy image CI is completed at time t2. Although a period of time necessary to copy an entire operation environment (=execution context EC+copy image CI) might be occasionally made longer, a period of time before starting a task in the destination server 200 is shortened. It is preferable from a viewpoint of continuity in providing services.

The method of setting a server operation environment according to the present invention will be described below in detail.

### First Exemplary Embodiment

In a first exemplary embodiment, the source server 100 and the destination server 200 are meant to be virtual machines (VM) which are realized by a server virtualization technique.

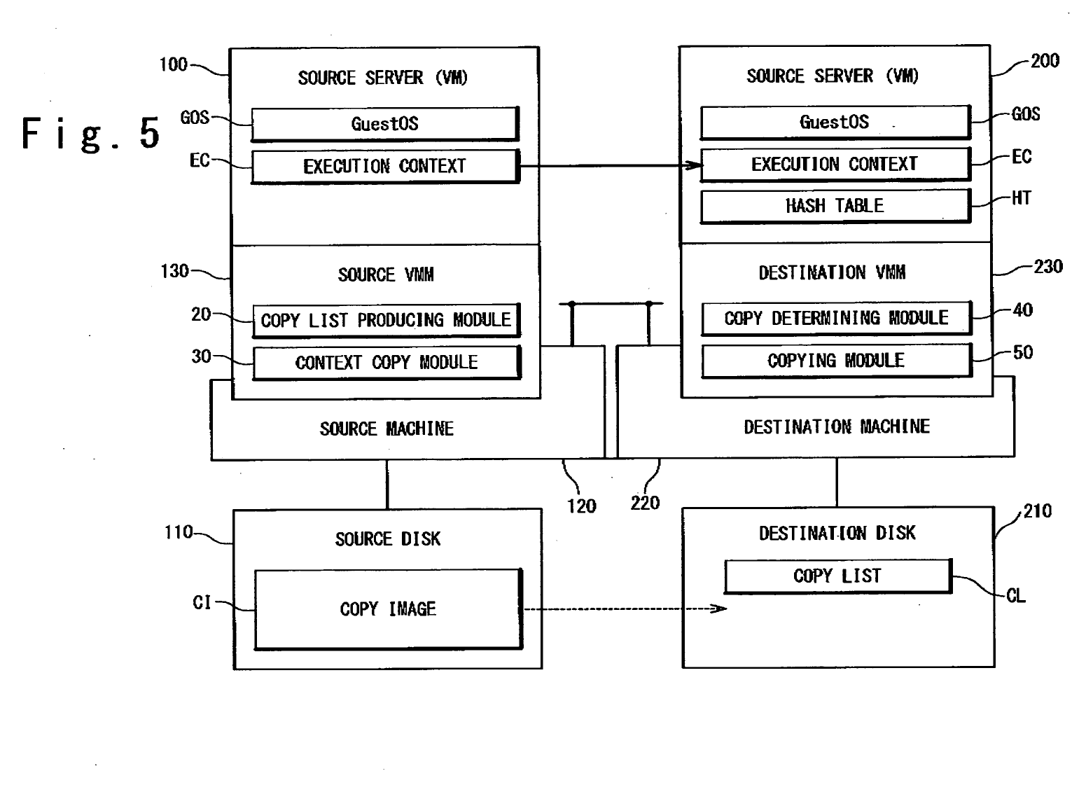

FIG. 5 shows a configuration according to the first exemplary embodiment. In FIG. 5, actual computers 120 and 220 are connected to each other via a network such as a LAN. The actual computer 120 is accessible to the source disk 110, and referred to as a source machine 120. Meanwhile, the actual computer 220 is accessible to the destination disk 210, and referred to as a destination machine 220.

A virtual machine monitor (VMM) is mounted onto each of the actual computers 120 and 220. The VMM is software executed on an actual computer, and capable of constructing and controlling a plurality of VMs. Specifically, a source VMM 130 mounted onto the source machine 120 provides the source server 100 as a virtual server, and controls an operation thereof. A destination VMM 230 mounted onto the destination machine 220 also provides the destination server 200 as a virtual server, and controls an operation thereof. The source server 100 uses the source disk 110, and the destination server 200 uses the destination disk 210.

In the present exemplary embodiment, the transfer of an operation environment of the source server 100 to the destination server 200 is realized by cooperation between the source VMM 130 and the destination VMM 230. Therefore, the source VMM 130 has a copy list producing module 20 and a context copying module 30. The destination VMM 230 also has a copy determining module 40 and a copying module 50.

Next, an operation of a server system in the present exemplary embodiment will be described. The source VMM 130 configures the source server 100 on the source machine 120 before transferring an operation environment, in which a guest OS (GOS) of the source server 100 executes various processes. Meanwhile, in the destination machine 220, the destination VMM 230 is capable of providing a virtual hardware configuration of the destination server 200, but a guest OS is undefined, so that the destination server 200 is not yet operated. Moreover, in case of a VM environment, it is not necessary to compare a hardware configuration (slot position of IO card, etc.) between the source server 100 and the destination server 200 prior to transfer the operation environment. However, a capacity of the destination disk 210 needs to be equal to or larger than a capacity of the source disk 110.

A method to setting a server operation environment in the present exemplary embodiment will be described with reference to FIGS. 3 and 5. In the present exemplary embodiment, the copy image CI is the entire disk image 10 of the source disk 110.

### Step S10:

First, in response to an instruction from a user, the source VMM 130 suspends an operation of the source server 100. Therefore, a task executed by the source server 100 is suspended.

### Step S20:

The copy list producing module 20 of the source VMM 130 produces the copy list CL with reference to the copy image CI on the source disk 110. The copy list CL is a list of files that are included in the copy image CI, and that need to be copied to the destination disk 210. The copy list producing module 20 transfers the produced copy list CL to the destination VMM 230. The destination VMM 230 stores the received copy list CL in the destination disk 210.

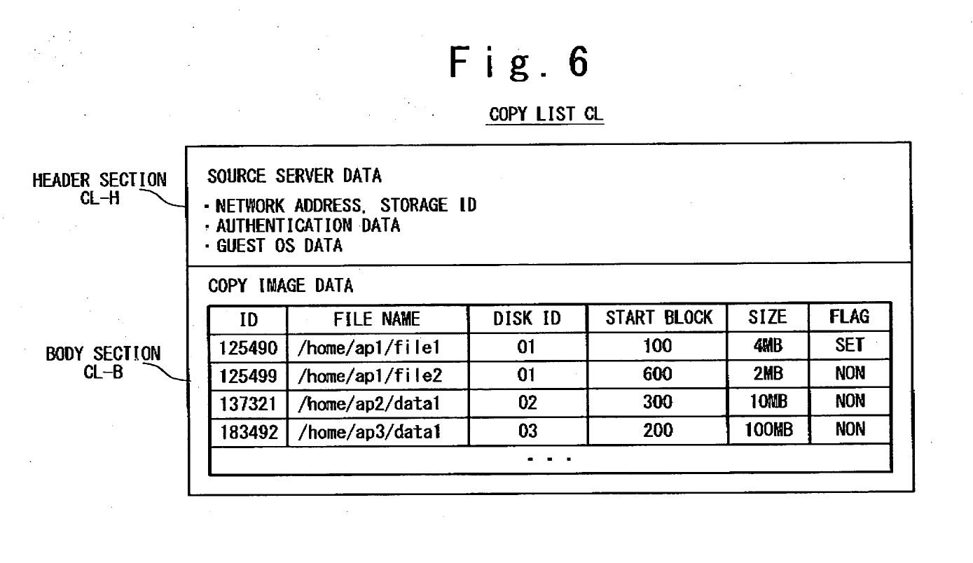

FIG. 6 shows an example of the copy list CL. As shown in FIG. 6, the copy list CL is configured by a header portion CL-H and a body section CL-B. The header section CL-H indicates a data related to the source server 100, including a network address, authentication data, and guest OS data. For example, the network address indicates where the source server 100 exists on a network, and the guest OS data indicates an ID of a guest OS to be transferred.

Meanwhile, the body section CL-B indicates a list of files of the copy image CI. For example, the body section CL-B indicates a name, an ID of the disk, a position within the disk (start block), and a block size with respect to each file, as shown in FIG. 6. Furthermore, the body section CL-B has a flag (copy data) which indicates whether or not each file has been copied. At the time of producing the copy list CL, entire flags are set to an uncopied state.

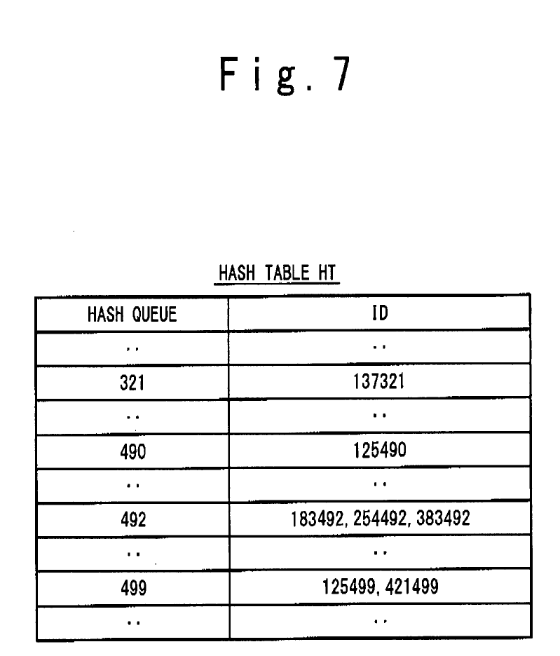

As will be described below, a file as an access target is searched from the body section CL-B of the copy list CL. In order to enhance a search speed, a hash table HT may be used as shown in FIG. 7. In the hash table HT, a hash key corresponds to an ID. The ID corresponds to each ID indicated in the body section CL-B of the copy list CL. By using the hash table HT as described above, it is made possible to search whether or not the file entry exists on the copy list CL at high speed. In case of using the hash table HT, the copy list producing module 20 produces the hash table HT based on IDs in the copy list CL at a same time as producing the copy list CL. Then, the copy list producing module 20 transfers the produced hash table HT to the destination VMM 230. The destination VMM 230 develops the hash table HT in an RAM (not shown) of the destination server 200.

### Step S30:

The context copying module 30 of the source VMM 130 transmits the execution context EC of the source server 100 to the destination VMM 230. The destination VMM 230 transfers the execution context EC to the destination server 200. Thus, the execution context EC of the source server 100 is copied to the destination server 200. At this time, the guest OS (GOS) is defined in the destination server 200.

### Step S40:

The destination VMM 230 restarts an operation of the destination server 200. Therefore, the suspended task is restarted in the destination server 200.

### Step S50:

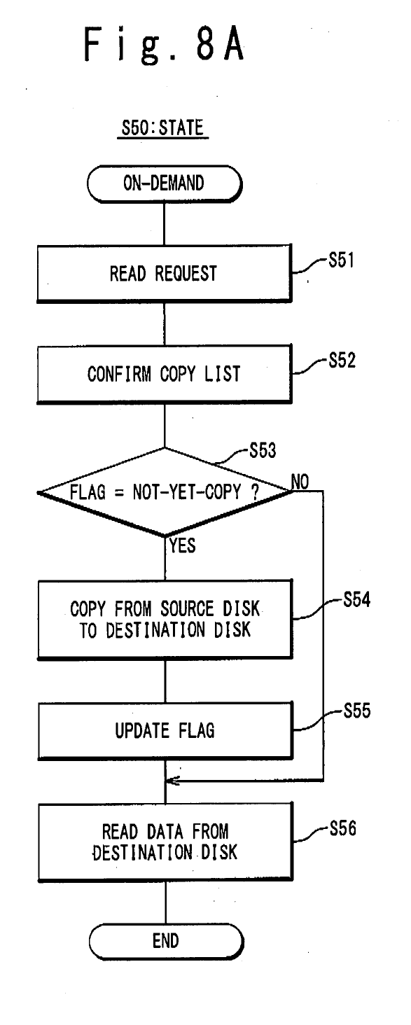

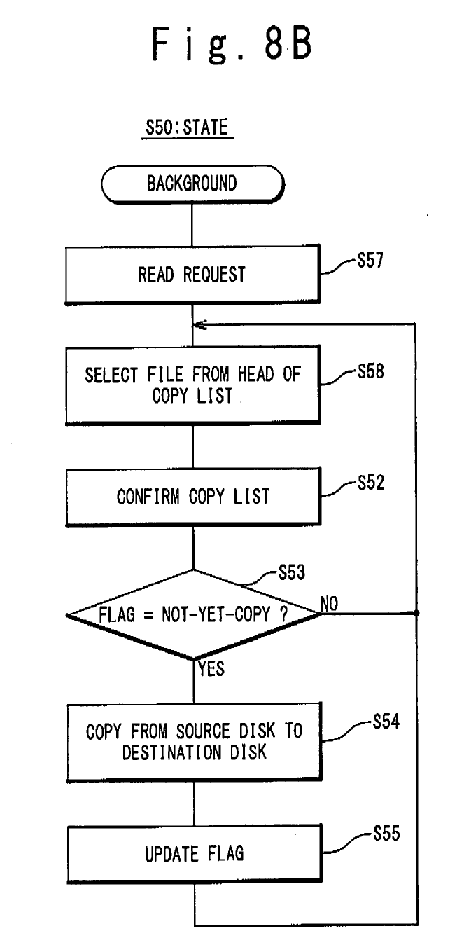

Thereafter, the copy image CI is copied from the source disk 110 to the destination disk 210 during the execution of a task by the destination server 200. The copy image CI is copied in an on-demand and/or background. FIGS. 8A and 8B are flowcharts showing details of step S50.

### Step S51:

In case of an on-demand copy as shown in FIG. 8A, access (read request) to the destination disk 210 is initially generated from a program in the operation state (ex. guest OS). At this time, a background copy to be described below is temporarily suspended.

### Step S52:

The copy determining module 40 of the destination VMM 230 determines whether or not an entity of target data as an access target exists in the destination disk 210. In the present exemplary embodiment, the copy determining module 40 refers to the above-described copy list CL to realize determination on the basis of the copy list CL.

Specifically, the copy determining module 40 checks whether the target data is included in the copy list CL. Here, the copy determining module 40 may use the hash table HT to check whether or not the file is hit in the hash table MT. If the target data is included in the copy list CL, the copy determining module 40 checks a flag corresponding to the target data (refer to FIG. 6). The copy determining module 40 can determine whether or not an entity of the target data exists in the destination disk 210, depending on a copied or uncopied state of the flag.

### Step S53:

If the flag indicates the copied state (step S53; No), the target data has been already copied. Accordingly, the target data is read from a block specified on the destination disk 210 (step S56). The read data is returned to a request source of the data. Meanwhile, if the flag indicates the uncopied state (step S53; Yes), the target data has been not yet copied. That is, it is understood that access to an uncopied area is generated. In this case, the control flow moves on to step S54.

### Step S54:

The destination VMM 230 communicates with the source VMM 130 to request a copy of the target data. More specifically, the copying module 50 of the destination VMM 230 refers to the header section CL-H and the body section CL-B of the copy list CL in order to recognize the source VMM and the storage data on the target data (refer to FIG. 6). Then, the copying module 50 requests the source VMM 130 to copy the target data on the basis of these data. In response to the copy request, the source VMM 130 reads the target data in the copy image CI from the source disk 110, so that the read target data is returned to the destination VMM 230. The destination VMM 230 writes the target data in a block specified on the destination disk 210. Thus, an entity of the target data is copied from the source disk 110 to the destination disk 210.

### Step S55:

When the target data is copied to the destination disk 210, the copying module 50 updates the copy list CL. That is, the copying module 50 changes the flag corresponding to the target data from the “uncopied state” to the “copied state”. Thereafter, the target data is read from the block specified on the destination disk 210 (step S56).

A background copy plays a role to complement the above-described on-demand copy. Since the copy image CI includes files which are hardly accessed, there is a possibility that a period of time necessary to complete a copy of the entire copy image CI might be extended in the exclusive on-demand copy. A period of time necessary to copy the entire copy image CI can be shortened by using a background copy in combination. The background copy can be similarly performed by the destination VMM 230.

### Step S57:

In case of the background copy as shown in FIG. 8B, the destination VMM 230 issues a start request. For example, the destination VMM 230 monitors a system load and when the system load is light, the copy determining module 40 is instructed to start the background copy.

### Step S58;

The copy determining module 40 refers to the copy list CL in order to select files from the head of the file list.

The subsequent steps are similar to those of the on-demand copy. The copy determining module 40 checks a flag corresponding to each of the files selected in the copy list CL (step S52). If the flag indicates the “copied state” (step S53; No), the control flow returns to step S58, so that a subsequent file is selected. If the flag indicates the “uncopied state” (step S53; Yes), the above-described steps S54 and S55 are performed. When the step S55 is ended, the control flow returns to step s58 to select a subsequent file. If the on-demand copy is generated or a system load is made heavier, the destination VMM 230 suspends the background copy.

In this way, it is made possible to copy the copy image CI from the source disk 110 to the destination disk 210 during the execution of a task in the destination server 200. Accordingly, it is not necessary to copy an entity of the copy image CI in a period until the operation is restarted in the destination server 200 after the operation of the source server 100 is suspended. As a result, a suspended time of the task is shortened. The processes performed by the source VMM 130 and the destination VMM 230 may also be executed by a predetermined management VM (virtual management server) in the present exemplary embodiment.

### Second Exemplary Embodiment

In a second exemplary embodiment, the source server 100 and the destination server 200 are realized by an actual computer or computers. The same reference numerals are assigned to the same components as in the first exemplary embodiment, and the same description will be appropriately omitted.

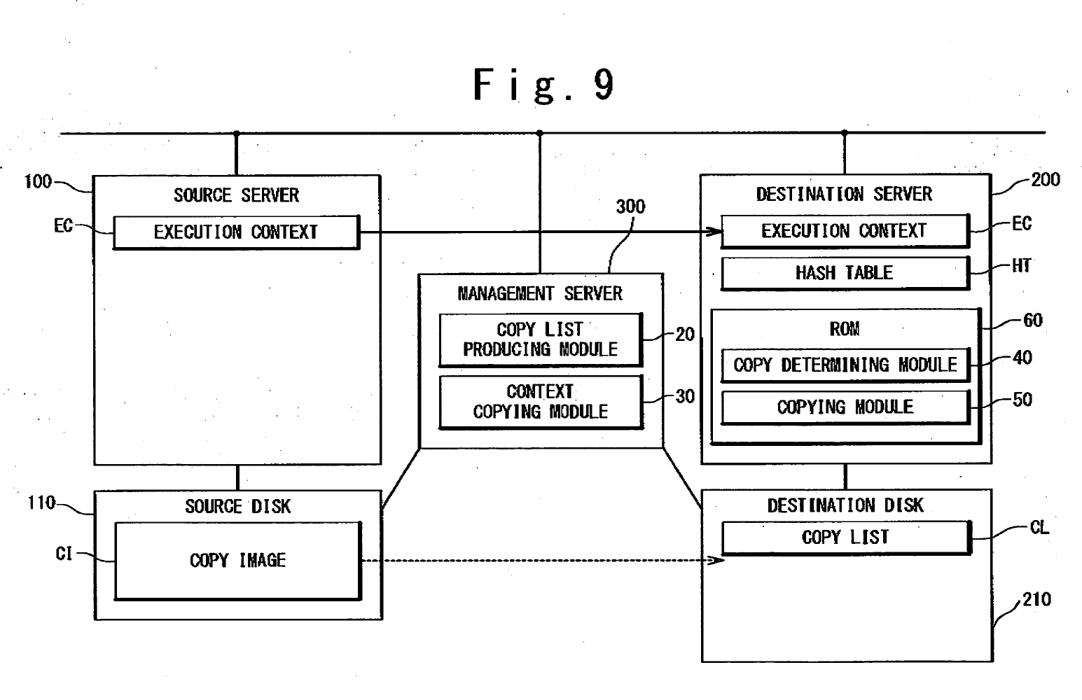

FIG. 9 shows a configuration of the server system according to the second exemplary embodiment. The sever system according to the present exemplary embodiment is provided with the source server 100 and the destination server 200 that are connected to each other via a network such as a LAN, in addition to a management server 300. The management server 300 is a server which manages entire servers. The source disk 110 is directly connected to the source server 100, and the destination disk 210 is directly connected to the destination server 200. The management server 300 is accessible to both the source disk 110 and the destination disk 210.

In the second exemplary embodiment, the management server 300 has the copy list producing module 20 and the context copying module 30. These modules 20 and 30 are realized through cooperation of a central processing unit (CPU) and software.

Moreover, the destination server 200 has the copy determining module 40 and the copying module 50 in the second exemplary embodiment. For example, an ROM 60 in which software for firmware is stored, is mounted onto the destination server 200. The copy determining module 40 and the copying module 50 are realized by the firmware.

Next, the server system in the second exemplary embodiment will be described. Prior to setting an operation environment, a hardware configuration (slot position of IO card, etc.) is compared between the source server 100 and the destination server 200, so that it is confirmed that a disk image can be taken over.

A method of setting a server operation environment in the second exemplary embodiment will be described with reference to FIGS. 3 and 9. In the present exemplary embodiment, the copy image CI is the entire disk image 10 of the source disk 110.

### Step S10:

First, an operation of the source server 100 is suspended by a user or the management server 300. Therefore, a task executed by the source server 100 is suspended.

### Step S20:

The copy list producing module 20 of the management server 300 accesses the copy image CI on the source disk 110 to produce the copy list CL. The copy list producing module 20 stores the produced copy list CL in the destination disk 210. The copy list producing module 20 may also produce the hash table HT at a same time as producing the copy list CL. In this case, the copy list producing module 20 develops the produced hash table HT in an RAM (not shown) of the destination server 200.

### Step S30;

The context copying module 30 of the management server 300 accesses the source server 100 to obtain the execution context EC of the source server 100. Then, the context copying module 30 sends the execution context EC to the destination server 200. Thus the execution context EC of the source server 100 is copied to the destination server 200.

### Step S40:

An operation starts in the destination server 200, in which the suspended task is restarted. The copy determining module 40 and the copying module 50 in the ROM 60 also start the operation.

### Step S50:

Thereafter, the copy image CI is copied from the source disk 110 to the destination disk 210 during the execution of the task by the destination server 200. The control flow in the copy is similar to the already-provided flow as shown in FIGS. 5A and 8B.

### Step S51:

First, access (read request) to the destination disk 210 is generated from an OS or program in the operation state. At this time, the background copy is temporarily suspended.

### Step S52:

When the request is generated, the copy determining module 40 determines whether or not an entity of target data as an access target exists in the destination disk 210. Specifically, the copy determining module 40 refers to the above-described copy list CL in order to realize determination on the basis of the flag corresponding to the target data. At this time, the hash table HT may also be used.

### Step S53:

If the flag indicates the “copied state” (step S53; No), the target data is read from a block specified on the destination disk 210 (step S56). The read data is returned to a request source of the data. Meanwhile, if the flag indicates the “uncopied state” (step S53; Yes), the control flow moves on to step S54.

### Step S54:

The copying module 50 of the destination server 200 refers to the header section CL-H and the body section CL-B of the copy list CL in order to recognize the source VMM and the storage concerned data on target data (refer to FIG. 6). Then, the copying module 50 instructs to copy the target data on the basis of these data.

For example, the copying module 50 requests the management server 300 to copy target data. The management server 300 accesses the source disk 100 on the basis of the copy request, so that the target data is read from the copy image CI. Then, the management server 300 accesses the destination disk 210 to write the target data in a specified block. Thus, an entity of the target data is copied from the source disk 110 to the destination disk 210.

Alternatively, a copy of the target data may be realized by an RPC (remote procedure call) between the destination server 200 and the source server 100. The copying module 50 requests the source server 100 to copy the target data. In response to the copy request, the OS of the source server 100 restarts an operation temporarily in order to read target data from the copy image CI on the source disk 110. The OS of the source server 100 sends the read target data back to the destination server 200. The copying module 50 writes the target data into the block specified on the destination disk 210. Thus, the entity of the target data is copied from the source disk 110 to the destination disk 210.

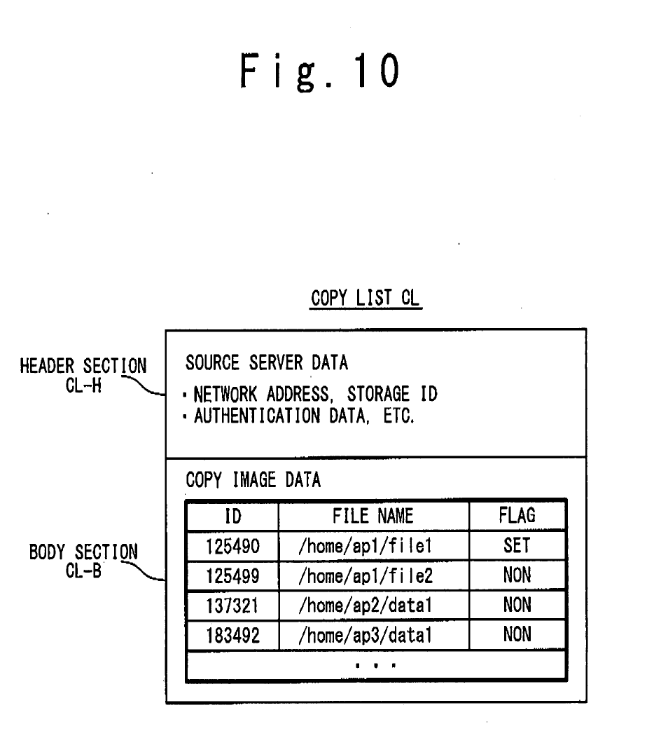

In case of this RPC communication, the destination server 200 is not required to recognize a detailed location and size of the target data. This is because the source server 100 recognizes a detailed location and size of the target data. Accordingly, the copy list CL to be produced in the present exemplary embodiment may be simplified as shown in FIG. 10. In comparison with the copy list CL shown in FIG. 6, a disk ID, start block and size are omitted. The copy list CL shown in FIG. 10 indicates a relationship between a file name and a flag (copy data). In this case, a size of the copy list CL is reduced, which is preferable. The copying module 50 requests the source server 100 to copy the target data by specifying a file name.

### Step S55:

When the copy of the target data is completed, the copying module 50 changes the flag corresponding to the target data from the “uncopied state” to the “copied state”. Thereafter, the target data is read from the block specified on the destination disk 210 (step S56).

### Step S57:

A background copy plays a role to complement the above-described on-demand copy. The OS of the destination server 200 issues a start request. For example, the OS monitors a system load, and if the system load is light, the copy determining module 40 is instructed to start a background copy.

### Step S58:

The copy determining module 40 refers to the copy list CL in order to select files from the head of a file list.

The subsequent steps are similar to those of the on-demand copy. The copy determining module 40 checks the flag corresponding to the file selected in the copy list CL (step S52). If the flag indicates the “copied state” (step S53; No), the control flow returns to step S58, so that a subsequent file is selected. If the flag indicates the “uncopied state” (step S53; Yes), the above-described steps S54 and S55 are executed. When the step S55 is ended, the control flow returns to step S58 to select a subsequent file. If the on-demand copy is generated or a system load is made heavier, the OS suspends a background copy.

In this way, it is made possible to copy the copy image CI from the source disk 110 to the destination disk 210 during the execution of the task by the destination server 200. Accordingly, it is not necessary to copy the entity of the copy image CI in a period from suspension of the operation of the source server 100 to restart of the operation in the destination server 200. As a result, the suspension time of the task is shortened.

### Third Exemplary Embodiment

In the already-provided exemplary embodiments, the copy image CI to be copied at step S50 is the entire disk image 10. On the contrary, in a third exemplary embodiment, a part of the disk image 10 is distributed to the destination disk 210 in advance before suspending the task. Then, the remaining image is exclusively copied at the step S50 after restarting the task. For example, a general image obtained immediately after installing an OS in the source server 100 is distributed to candidates which may be a destination in advance. In this case, a portion which was changed after an OS installation is copied as the copy image CI at the step S50.

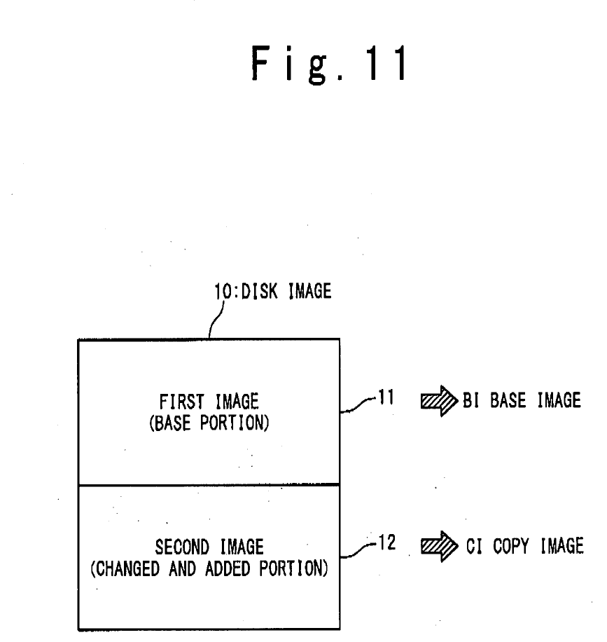

More generally, a copy is made as follows. FIG. 11 conceptually shows division of the disk image 10 in the third exemplary embodiment. The disk image 10 is divided into a first image 11 and a second image 12. The first image 11 is an image which becomes a reference to produce the copy image CI, and referred to as a “base image BI”. This base image BI is distributed in advance to the candidates which may be the destination before suspending the task.

Meanwhile, the second image 12 is a difference between the disk image 10 and the base image BI. A portion added after producing the base image BI and a portion changed in the base image BI are included in the second image 12. This second image 12 is copied as the copy image CI at the step S50.

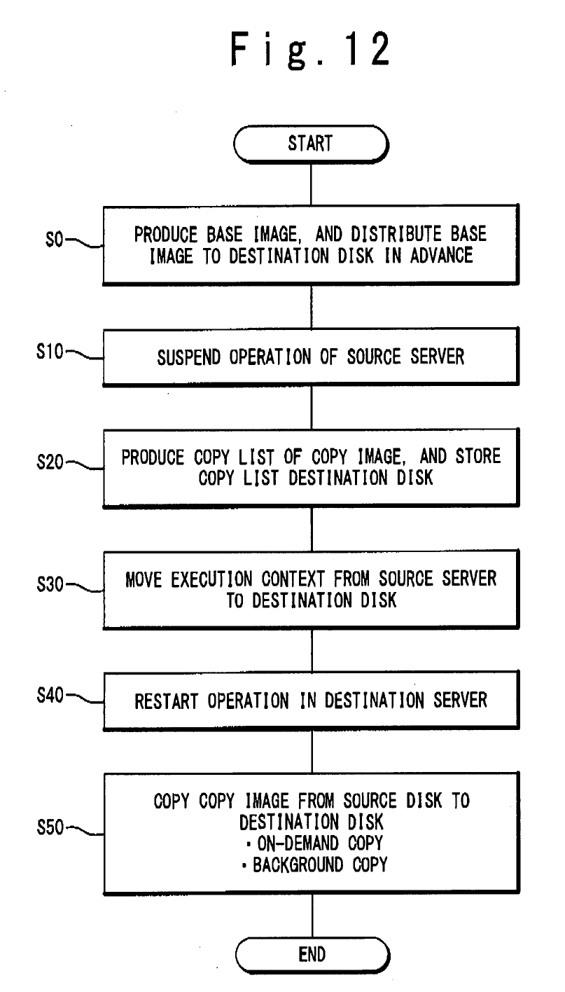

FIG. 12 is a flowchart showing a method of setting a server operation environment according to the third exemplary embodiment. The description of the same portion as made in the already-provided exemplary embodiments is appropriately omitted.

In the present exemplary embodiment, step S0 is newly provided before the above-described step S10. That is, the base image BI is produced at timing prior to step S10. The base image BI is a part of the disk image 10 of the source disk 110. The produced base image BI is stored in a predetermined disk. Then, the base image BI is distributed to the destination disk 210 of the destination server 200 in advance prior to the step S10.

The copy image CI is also a part of the disk image 10. This copy image CI is a difference between the disk image 10 obtained at step S10 and the above-described base image BI. A portion added after producing the base image BI and a portion changed in the base image SI are included in the copy image CI. In step S20, the copy list CL related to the copy image CI is produced. At step S50, the copy image CI is copied by with reference to the copy list CL.

According to the present exemplary embodiment, a size of the copy image CI is reduced in comparison with the already-provided exemplary embodiments. As a result, a period of time required for the step S50 is shortened. In other words, a period from t0 to t2 as shown in FIG. 4 is shortened, so that a period to complete the copy of the entire operation environment is shortened. The present exemplary embodiment may be combined with any of the already-provided exemplary embodiments. Further details of the present exemplary embodiment will be described below by using a detailed example.

### Examples

FIG. 13 shows an example of a configuration the server system corresponding to that (VM environment) shown in the first exemplary embodiment. The source VMM 130 further has a base image producing module 70 and a base image distributing module 80. The base image producing module 70 produces the base image BI. The base image distributing module 80 distributes the base image BI to the destination disk 210.

FIG. 14 shows another example of a configuration corresponding to the configuration (actual computer environment) shown in the second exemplary embodiment. In FIG. 14, the management server 300 has the base image producing module 70 and the base image distributing module 80. These modules 70 and 80 are realized through cooperation of a CPU and software.

A method of setting a server operation environment in the present example will be described with reference to FIGS. 12 to 14. In the present example, the copy image CI is a part of the disk image 10 of the source disk 110.

### Step S0:

Prior to a step S10, the base image producing module 70 accesses the source disk 110 to produce the base image BI. It can be said that this base image BI is a backup of the disk image 10 at a current point of time. The produced base image BI is stored in a predetermined disk. For example, the produced base image BI is stored in the source disk 110.

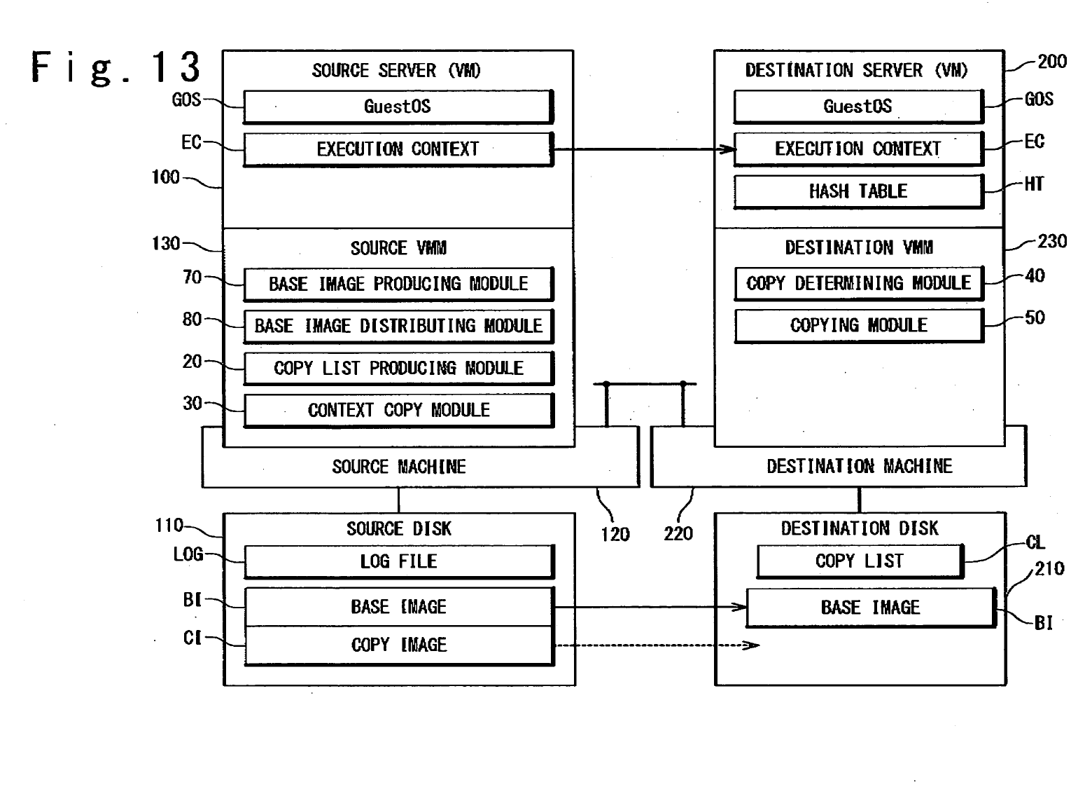

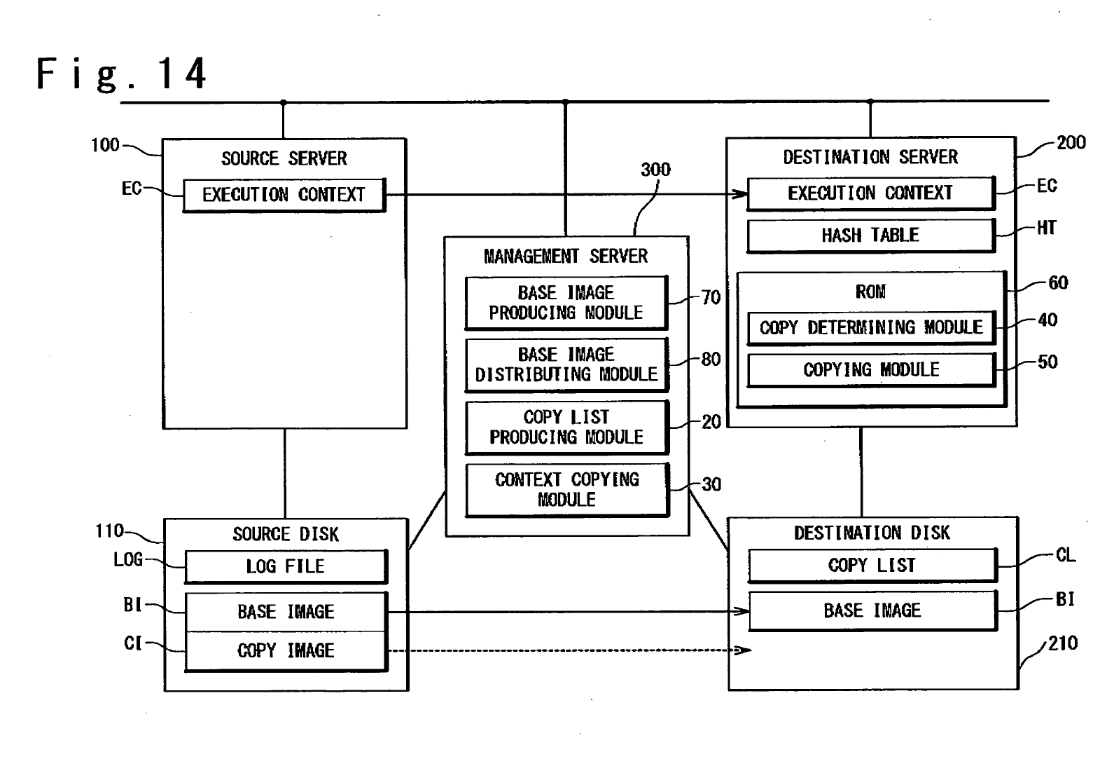

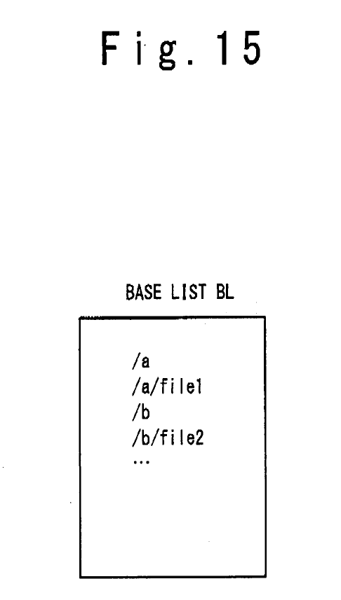

Alternatively, the base image producing module 70 may produce a list of files of the disk image 10 at a current point of time, instead of producing the base image BI for a backup. FIG. 15 shows the list of files as described above (referred to as a “base list BL” hereinafter). The base list BL shows files included in the disk image 10 of the source disk 110 at a point of time of step S0 in a list format.

Thereafter, an operation of the source server 100 is continued, and files are added and the files are changed on the source disk 110.

Moreover, the base image distributing module 80 reads the base image BI at timing prior to the step 10, and distributes the base image BI to candidates which may be a destination. If the base image BI exists, the base image distributing module 80 reads the base image BI without making any changes.

Meanwhile, if the base list BL as shown in FIG. 15 is produced, the base image distributing module 80 refers to the base list BL in order to read a portion which is equivalent to the base image BI, from the source disk 110. In case of the VM environment as shown in FIG. 13, the base image distributing module 80 of the source VMM 130 sends the base image BI to the destination VMM 230. The destination VMM 230 stores the base image BI in the destination disk 210. In case of an actual computer environment as shown in FIG. 14, the base image distributing module 80 of the management server 300 can directly write the base image BI in the destination disk 210.

### Step S10:

Thereafter, the operation of the source server 100 is suspended at the step S10. At this time, a difference between the disk image 10 and the above-described base image BI becomes the copy image CI. A portion added after the step S0 and a portion changed in the base mage BI are included in the copy image CI.

FIG. 16 shows various patterns related to the base image BI and the copy image CI. For example, in case of a pattern (a), a disk image obtained immediately after installing an OS in the source server 100 is used as the base image RI. That is, the above-described step S0 is performed immediately after the OS installation. In this case, the base image BI is general, so that distribution to the destination candidates is made easier. Meanwhile, a portion added/changed after the OS installation becomes the copy image CI. The added/changed portion is recorded in a log file LOG on the source disk 110. The copy list CL which is a file list of the copy image CI can be produced from the log file LOG.

In case of a pattern (b), a disk image obtained at a point of time to complete an application installation and task/user setting is used as the base image BI. That is, at a point of time to complete the application installation and the task/user setting, the above-described step S0 is performed. Then, the portion changed/added thereafter becomes the copy image CI. The added/changed portion is recorded in a log file LOG on the source disk 110. In this case, the base image DI is specialized in a task of the source server 100. However, in comparison with the case of the pattern (a), a size of the copy image CI to be copied at the step S50 is reduced more.

In case of a pattern (c), predetermined timing during operation of the source server 100 is set to a starting point (step S0). A disk image obtained at the starting point is instantaneously captured by a split mirror function or the like, so as to be used as the base image BI. Then, the portion added/changed after the starting point becomes the copy image CI. Similarly, the added/changed portion is recorded in the log file LOG on the source disk 110. In the case of this pattern (c), a size of the copy image CI to be copied at the step S50 is reduced most.

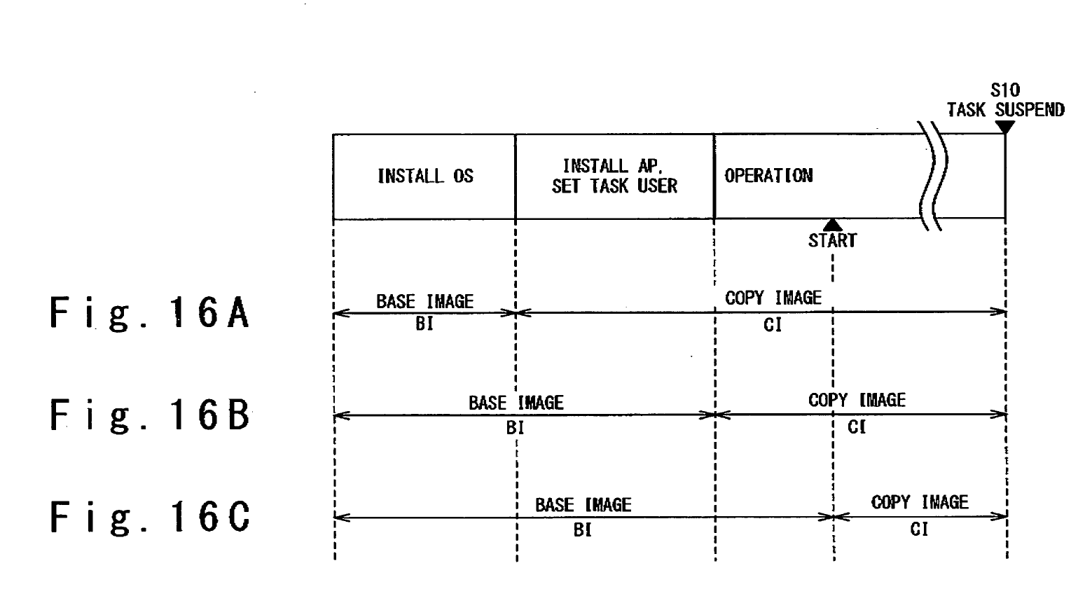

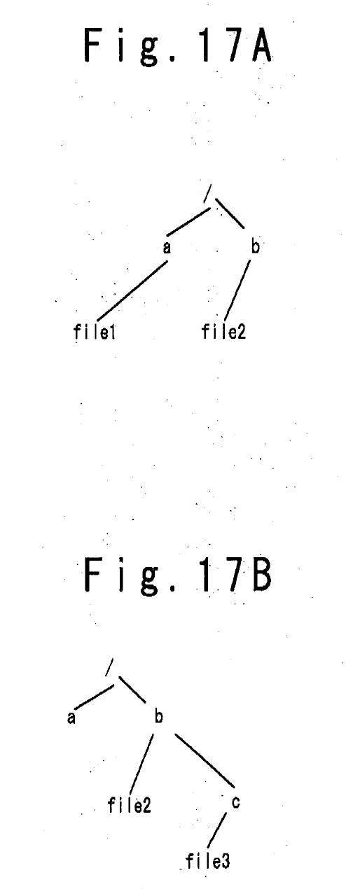

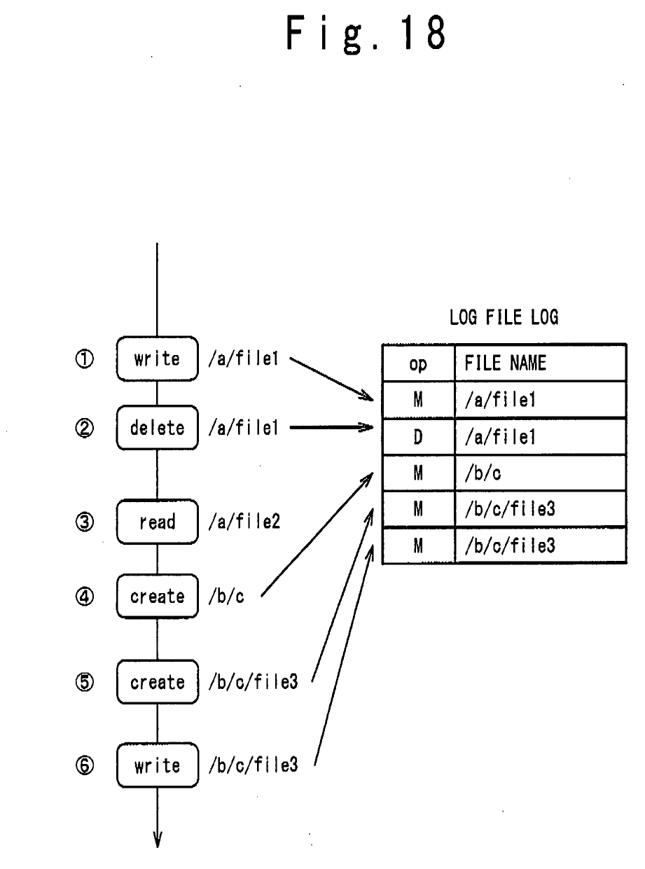

A method of producing the log file LOG after the step S0 will be described as an example. FIGS. 17A and 17B conceptually show examples of changing a disk image after the step S0. While deleting a file /a/file1, the remaining files /b/c and /b/c/file3 are produced. FIG. 18 shows an example of an operational sequence corresponding to the change shown in FIG. 17.

1. Write into /a/file1

2. Delete /a/file1

3. Read /a/file2

4. Create /b/c

5. Create /b/c/file3

6. Write into /b/c/file3

FIG. 18 also shows the log file LOG to be produced in accordance with the above-described operational sequence. An operation code op and a file name are stored in each entry of the log file LOG with a correspondence relation. The operation code op is set to either M (modify) or D (delete). In case of writing, because file contents are changed, “M” is selected. In case of reading, because file contents are not changed, it is not necessary to leave a record in the log file LOG. In case of deleting a file, “D” is selected. In case of producing the file, “M” is selected. In case of transferring a file, “D” is selected with respect to the file of a source, and “M” is selected to a file of a destination. The log file LOG which indicates operation history of a file on the source disk 110 is thus produced.

### Step S20:

The copy list producing module 20 produces the copy list CL which is a list of files included in the copy image CI. Here, the above-described log file LOG indicates data on a change of a file from production of the base image BI (step S0) to suspension of a task (step S10). Accordingly, the copy list producing module 20 can produce the copy list CL by referring to the log file LOG and analyzing it.

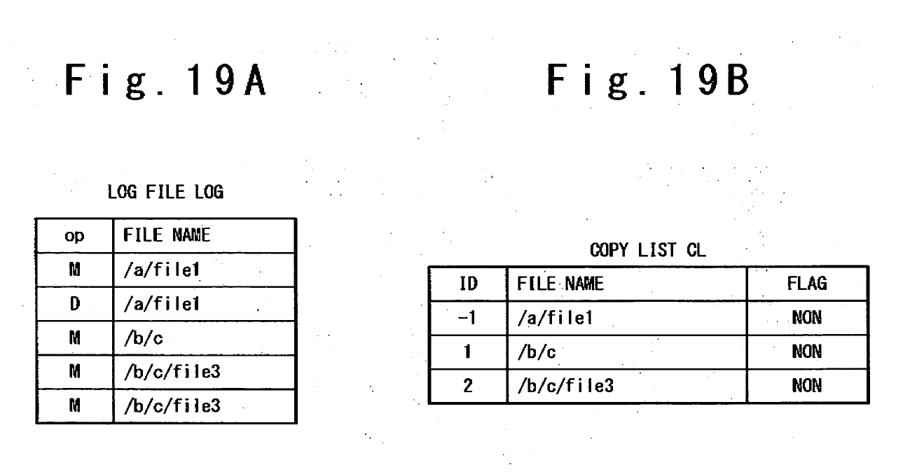

FIGS. 19A and 19B show an example of producing the copy list CL from the log file LOG shown in FIG. 18. In the copy list CL, one entry is allocated to one file. A file name appeared in the log file LOG is used as a file name without making any change. If a plurality of entries with the same file name exist in the log file LOG, an entry appeared in the last in the log file LOG is referred.

For example, an entry “D, /a/file1” in the log file LOG is referred with respect to the file /a/file1. If the operation code op is “D”, “−1” is allocated as an ID in the copy list CL. An entry “M, /b/c” in the log file LOG is referred with respect to the file /b/c. If the operation code op is “M”, a “unique ID” is allocated as an ID in the copy list CL. In this case, the unique ID is “1”. An entry “M, /b/c/file3” in the log file LOG is referred with respect to the file /b/c/file3. In this case, “2” is allocated as the unique ID. Entire flags are set to have the “uncopied state” as an initial state.

Thus, the copy list CL is produced. In FIG. 19, each entry of the copy list CL has an allocated ID, a file name, and a flag. Furthermore, the above-described hash table HT can also be produced on the basis of an ID in the copy list CL.

In the background copy at the step S50, a file with the ID of “−1” is deleted from the destination disk 210. The remaining steps are similar to those of the already-provided exemplary embodiments.

In a VM environment, there are also known functions such as a “VMware nonpersistent mode” and “UnionFS” as a technique to manage images by separating an image obtained at a certain period of time from a portion to be changed thereafter. The base image BI and the copy image CI may be managed by using these functions.

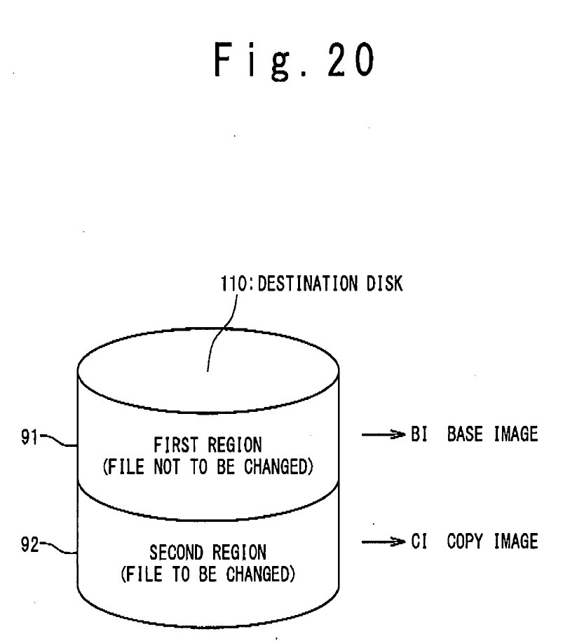

As another example, FIG. 20 shows an example of realizing division between the base image BI and the copy image CI by managing files of the source disk 110. As shown in FIG. 20, the source disk 110 is managed by dividing into a first region 91 and a second region 92. The first region 91 exclusively stores files in which a program or the like is not changed. Meanwhile, files in which application data or the like may be changed are stored in the second region 92. The rewrite of the file is performed exclusively to the second region 92. In this case, a disk image of the first region 91 shall be used as the base image BI. Moreover, the disk image of the second region 92 shall be copied as the copy image CI. In this case, the log file LOG used for tracking a changed portion is not required. Furthermore, the copy list producing module 20 can produce the copy list CL by accessing the second region 92.

According to the present examples, the same effect exhibited in the already-provided exemplary embodiments can be obtained. That is, the suspension time of the task is shortened. Furthermore, an amount of data to be copied at the step S50 is reduced, so that an additional effect of shortening the period from t0 to t2 in FIG. 4 can be obtained. In other words, a period to complete the entire operation environment is shortened.

Although the present invention has been described above in connection with several exemplary embodiments thereof, it will be apparent to those skilled in the art that those embodiments are provided solely for illustrating the present invention, and should not be relied upon to construe the appended claims in a limiting sense.

What is claimed is:

1. A method of setting an operation environment of a first computer using a first disk to a second computer using a second disk, comprising:
suspending an operation of said first computer;
producing a list of files contained in a copy image as at least a part of a disk image of said first disk, after the operation of said first computer is suspended;
copying execution context of said first computer to said second computer after the operation of said first computer is suspended;
restarting an operation of said second computer after the producing a list of files and the copying of execution context; and
referring to said list after the restarting to copy said copy image from said first disk to said second disk.

2. The method according to claim 1, wherein said copy image is an entire of said disk image.

3. The method according to claim 1, further comprising:
distributing a part of said disk image to said second computer as a base image prior to the suspension,
wherein said copy image is a difference between said disk image and said base image.

4. The method according to claim 3, wherein said distributing comprises:
producing said base image at a concerned timing prior to the suspension; and
distributing the produced base image to said second computer.

5. The method according to claim 4, wherein said concerned timing is immediately after an operating system is installed on said first computer.

6. The method according to claim 1, wherein said producing a list of files comprises:
storing the produced list in said second disk.

7. The method according to claim 1, wherein said referring comprises:
copying said copy image to said second disk of said second computer in a background of an operation of said second computer.

8. The method according to claim 1, wherein said referring comprises:
copying said copy image to said second disk of said second computer in on-demand in response to a request from said second computer.

9. The method according to claim 1, wherein said referring comprises:
checking whether an entity of an access target data exists when said second computer accesses said second disk; and
when it is determined that the entity of the access target data does not exist, referring to said list to copy said access target data in said copy image from said first disk to said second disk.

10. The method according to claim 9, wherein said list has a copy data to indicate whether each of the files contained in said copy image has been already copied,
said checking comprises:
carrying out the check based on said copy data corresponding to said access target data in said list, and
said referring to said list comprises:
changing the copy data corresponding to said access target data to a copied state.

11. A computer comprising:
a copy determining module configured to determine whether an entity of an access target data exists when a disk is accessed; and
a copying module configured to request an apparatus which is accessible to a source disk in which said access target data is stored, to copy said access target data to said disk when it is determined that the entity of said access target data does not exist.

12. The computer according to claim 11, wherein a list of files necessary to be copied is stored in said disk,
said list has a copy data to indicate whether each of the files has been copied,
said copy determining module carries out the determination based on said copy data corresponding to said access target data in said list, and
said copying module changes said copy data corresponding to said access target data after the copy of said access target data is complete.

13. The computer according to claim 12, wherein said copy determining module searches a data about said access target data from said list by using a hash table related to said list.

14. The computer according to claim 11, wherein said computer comprises:
a virtual machine; and
a virtual machine monitor configured to control said virtual machine,
wherein said virtual machine monitor has said copy determining module and said copying module.

15. A computer system in which an operation environment of a first computer using a first disk is set to a second computer using a second disk, comprising:
a copy list producing module configured to produce a copy list of files contained in a copy image of at least a part of a disk image of said first disk of said first computer; and
a context copying module configured to copy execution context of said first computer to said second computer after an operation of said first computer is suspended,
wherein the produced copy list is stored in said second disk.

16. The computer system according to claim 15, wherein said copy image is an entire of said disk image.

17. The computer system according to claim 15, further comprising:
a base image producing module configured to produce the part of said disk image as a base image before operation suspension of said first computer; and
a base image distributing module configured to distribute said base image to said second computer before the suspension of said first computer.

18. The computer system according to claim 17, wherein said copy list producing module produces said copy list based on a log file indicating change data of each file from the production of said base image to the suspension of the operation.

19. The computer system according to claim 15, wherein said computer system comprises:
a first real machine accessible to said first disk; and
a second real machine connected with said first real machine through a network and accessible to said second disk are provided,
wherein said first computer is a first virtual machine provided by a first virtual machine monitor operating on said first real machine,
said second computer is a second virtual machine provided by a second virtual machine monitor operating on said second real machine,
said first virtual machine monitor has said copy list producing module and said context copying module, and
said first virtual machine monitor copies said produced list and said execution context to said second disk and said second computer through said second virtual machine monitor.

20. The computer system according to claim 15, wherein said computer system comprises:
a management computer connected with said first computer and said second computer through a network and accessible to said first disk and said second disk,
wherein said management computer has said copy list producing module and said copying module, and
said management computer copies said produced list and said execution context to said second disk and said second computer.

21. A computer-readable software product for realizing a method which comprises:
analyzing a log file indicating a record of operations on a file on a first disk;
allocating a peculiar ID to said file when the last one of the operations of said record is a modify operation; and
producing a list of said peculiar ID, a name of said file, and a copy data indicating whether said file has been already copied.

22. The computer-readable software product according to claim 21, further comprising:
producing a hash table used for a search of said list based on said peculiar ID in said list.
